(19) United States
(12) Patent Application Publication
(10) Pub. No.: US 2008/0043024 A1
(43) Pub. Date: Feb. 21, 2008

(54) METHOD FOR RECONSTRUCTING AN OBJECT SUBJECT TO A CONE BEAM USING A GRAPHIC PROCESSOR UNIT (GPU)

(75) Inventors: Thomas Schiwietz, Munchen (DE); Supratik Bose, Concord, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., Princeton, NJ (US)

(21) Appl. No.: 11/745,535

(22) Filed: May 8, 2007

Related U.S. Application Data
(60) Provisional application No. 60/816,540, filed on Jun. 26, 2006.

(51) Int. Cl. G06T 11/20

(52) U.S. Cl. 345/442

(57) ABSTRACT

A method for reconstructing an object subject to cone beam passing through the object and generating projection images of the object using a graphic processing unit (GPU). The method applies a non-linear curvature-based smoothing filter to the projection images. The method applies a high-pass filter to the curvature-smoothed images. The method backprojects the projection images into an output volume using voxel driven backprojection. The method removes cupping artifacts from the output volume convolving every slice with a Butterworth kernel and adding the result to the slice weighted by a scaling factor.

### CROSS REFERENCE TO RELATED APPLICATION

This application claims priority from U.S. Provisional application Ser. No. 60/816,540 filed on Jun. 26, 2006, which is incorporated herein by reference.

### TECHNICAL FIELD

This invention relates generally to the use of Graphic Processing Units (GPUs) to accelerate reconstruction of slices from X-ray projection images acquired using a circular cone beam trajectory.

### BACKGROUND

As is known in the art, in early computerized tomography for either of medical or industrial applications, an x-ray fan beam and a linear array detector was used to achieve two-dimensional (2D) imaging. While an acquired data set may be complete and image quality is correspondingly high, only a single slice of an object is imaged at a time. Thus, if a 3D image is required, an approach which reconstructs a stack of slices is employed. Acquiring and Reconstructing a 3D data set one 2D slice at a time is inherently slow. Moreover, in medical applications, motion artifacts occur because adjacent slices are not imaged simultaneously. Also, dose utilization is less than optimal because the distance between slices is typically less than the x-ray collimator aperture, resulting in double exposure to many parts of the body. In 2D CT, the scanning path of the source is often simply a circular scan about the object.

More recently a system employing cone beam geometry has been developed for 3D imaging and includes a cone beam x-ray source instead of a fan beam source, and a 2D area detector instead of a linear array detector. An object to be imaged is scanned, preferably over a 360 degrees angular range, either by moving the x-ray source in a scanning path about the object or by rotating the object while the source remains stationary. In either case, the area detector is fixed relative to the source and relative movement between the source and object provides the scanning (irradiation of the object by the cone beam energy). Compared to the conventional 2D “stack of slices” approach to achieve 3D imaging, the cone beam approach has the potential to achieve 3D imaging of both medical and industrial applications both rapidly and with improved dose utilization.

As is also known in the art, in cone beam computed tomography (CT), a conical beam is used and three dimensional (3D) image reconstruction is based on the technique known as filtered back projection. Various methods have been developed for 3D image reconstruction for cone beam x-ray imaging systems. For example, a back projection cone beam image reconstruction technique is described in U.S. Pat. No. 5,257,183, which issued on Oct. 26, 1993 to Kwok C. Tam, entitled “Method and Apparatus for Converting Cone Beam X-Ray Projection Data To Planar Integral and Reconstructing a Three-Dimensional Computerized Tomography (CT) Image of an Object”, which is incorporated herein by reference.

As is also known, increasing sampling resolution of the projection images and the desire to reconstruct high-resolution output volumes increases both the memory consumption and the processing time considerably. In order to keep the processing time down, new strategies for memory management are required as well as new algorithmic implementations of the reconstruction pipeline. In the current generation of cone beam scanners, a typical projection image is obtained with 1024×1024 sample points at 16-bit dynamic range. Using software, the acquired projection images are converted into line integrals of attenuation through the objects (floating point 32 bit data) by applying familiar Beer-Lambert's law of exponential decay of intensity through absorbing medium of rays coming out of a monochromatic energy source, see Principles of Computerized Tomographic Imaging by Avinash C Kak and Malcolm Slaney, IEEE Press, 1988. This procedure ignores the fact that actual energy source is poly-energetic and besides actual absorption, other phenomena like scatter and beam hardening take place. The effect of these phenomena appear as cupping artifacts in the resultant reconstruction which are later removed by the pos-processing operation described in this invention. It is noted that “input” projection images are considered as line integrals of attenuation through the object obtained from original projection images. Usually, between 360 and 720 images are acquired during one rotation around the patient. Consequently, high quality data volumes can be reconstructed from those images. On the other hand, the data set size can grow up to several giga bytes and the processing time increases tremendously, too. Furthermore, for accurate and high-quality output volumes all calculations are typically performed in 32-bit floating point precision. This improves the image quality over fix-point formats at the price of even more memory consumption and longer processing time. To handle the large amount of data, an efficient memory management strategy is required to achieve fast turn-around times.

While in the past years, there have been a couple of cone beam reconstruction papers exploiting the power of GPUs like for example by Mueller and Xu [F. Xu and K. Mueller, “Accelerating popular tomographic reconstruction algorithms on commodity PC graphics hardware,” IEEE Transaction of Nuclear Science, 2005], they focus mainly on the reconstruction process itself using various algorithms like backprojection and algebraic reconstruction, the focus of the present invention is on the entire reconstruction pipeline with pre- and post-processing filters in high accuracy using floating-point precision.

### SUMMARY

In accordance with the present invention, a method is provided for reconstructing an object subject to cone beam passing through the object and generating projection images of the object, comprising: applying curvature-based smoothing and boundary adjustments to the projection images using GPU shader programs; applying high-pass filtering to the curvature-smoothed and boundary adjusted images using GPU shader programs; reconstructing the object from the applied high pass filtering using backprojection using GPU shader programs; and removing ring and cupping artifacts from the reconstructed object using GPU shader programs.

In one embodiment, a method is provided for reconstructing an object subject to a cone beam passing through the object and generating projection images of the object. The method includes: applying a non-linear curvature-based smoothing filter to the projection images; applying a high-pass filter to the curvature-smoothed images; backprojecting the high pass filtered images into an output volume using voxel driven backprojection; removing cupping artifacts from the output volume convolving every slice with a Butterworth kernel and adding the result to the slice weighted by a scaling factor.

In one embodiment, the output volume is divided into chunks, wherein a chunk is a stack of slices representing a part of the entire output volume.

In one embodiment, a method is provided for reconstructing an object subject to cone beam passing through the object and generating projection images of the object. The method includes applying a non-linear curvature-based smoothing filter to the projection images, such filter smoothing the projection images in uniform regions while preserves edges of the images by including local curvature and gradient magnitude effects. The method applies a high-pass filter to the curvature smoothed images using a FFT to convolve the projection images with a high-pass filter. The method backprojects the projection images into an output volume using voxel driven backprojection, wherein for each voxel in the output volume the process request the corresponding pixel in the projection images, such backprojection comprising counting the number of rays passing through each voxel and discarding voxels below a user-defined minimum ray limit. The method removes artifacts from the output volume comprising: removing ring artifacts from the output volume using radial median filtering and circular smoothing. The method removes cupping artifacts from the output volume comprising convolving every slice with a Butterworth kernel and adding the result to the slice weighted by a scaling factor.

In order to improve the reconstruction pipeline speed, the process according to the invention, takes advantage of the computational power of modern graphics processing units (GPUs). Although GPUs are not Turing-complete, they provide a powerful subset for parallel single instruction multiple data (SIMD)-type operations which outperform current CPUs even with streaming SIMD extension (SSE) 2 or 3 optimization. Furthermore, there is a second type of parallelism available on modern graphics cards: 32 to 48 pixel units exist on board executing SIMD operations in parallel. To better understand the architecture and advantages of using the GPU, a brief overview of GPU programming is presented below

The process according to the invention also uses an GPU accelerated implementation of the Fast Fourier transform (FFT) presented in papers by T. Schiwietz and R. Westermann, “GPU-PIV,” in VMV, pp. 151-158, 2004, and T. Schiwietz, T. Chang, P. Speier, and R. Westermann, “MR image reconstruction using the GPU,” in Medical Imaging 2006: Visualization, Image-Guided Procedures, and Display. Proceedings of the SPIE (2006)., pp. 646-655, April 2006.

In order to obtain the maximum performance of a GPU all computations according to the invention are executed by the GPU and the bus transfer between GPU memory and main memory is minimized. Therefore, the invention implements the entire reconstruction pipeline using GPU programs (shaders). A goal was to upload the projection images to GPU memory right after acquisition and download only the final output volume. Unfortunately, the memory consumption is very high. Therefore, the invention splits the volume into several parts (chunks) and reconstructs them separately.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a graphics card pipeline used in a GPU showing the three most important stages: the vertex shader, the geometry shader and the rasterizer/pixel shader;

FIGS. 2(a) and 2(b) show the effect of curvature smoothing used in the process according to the invention; FIG. 2(a) showing a noisy input image and FIG. 2(b) showing the same image after eight iterations of curvature smoothing. Obviously, the noise is gone and the edges of the bright circles are still sharp;

FIG. 3(a) shows the sampling pattern for a radial median filter; FIG. 3(b) shows the sampling pattern for circular smoothing; FIG. 3(c) shows a slice with significant ring artifacts; FIG. 3(d) shows a radial median filtered image that was subtracted from the original image; FIG. 3(e) shows the effect of the filter applied on the image in FIG. 3(d); and FIG. 3(f) is an image free of artifacts after ring artifact removal according to the invention;

FIG. 4(a) shows an input image; FIG. 4(b) shows the filter response after convolving the input image with the Butterworth filter; and FIG. 4(c) shows the image after cupping artifact correction according to the invention;

FIG. 5 shows an output volume divided into a number of chunks, according to the invention, where a chunk is a stack of slices representing a part of the entire volume;

FIG. 6 is a flowchart of the process according to the invention;

FIGS. 7A and 7B are flowcharts of a curvature process used in the process of FIG. 6;

FIGS. 8A and 8B are flowcharts of a high-pass filtering process used in the process of FIG. 6;

FIGS. 9A and 9B are flowcharts of a backprojection process used in the process of FIG. 6;

FIGS. 10A and 10B are flowcharts of a ring artifact process used in the process of FIG. 6;

FIGS. 11A and 11B are flowcharts of a cupping artifact process used in the process of FIG. 6, and

FIG. 12 is a block diagram of a system for reconstructing an object subject to cone beam passing through the object and generating projection images of the object in a GPU according to an exemplary embodiment of the present invention.

Like reference symbols in the various drawings indicate like elements.

### DETAILED DESCRIPTION

### General

As will be described in more detail below, in addition to the filtered backprojection (see L. A. Feldkamp, L. C. Davis, and J. W. Kress, “Practical cone-beam algorithm,” Optical Society of America Journal A 1, pp. 612-619, June 1984) (FDK) algorithm), the process implements the entire cone beam reconstruction pipeline including nonlinear smoothing of acquired raw data to the artifact removal of reconstructed output slices.

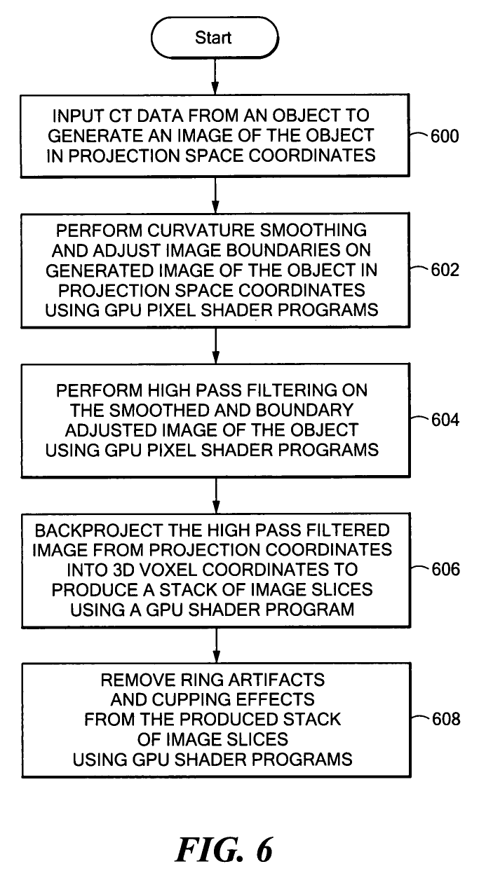

The process according to the invention, and as shown in the flowchart of FIG. 6, reconstructs an object subject to cone beam passing through the object and generating projection images of the object, comprising: applying curvature-based smoothing and boundary adjustments to the projection images using GPU shader programs (Step 600); applies high-pass filtering to the curvature-smoothed and boundary adjusted images using GPU shader programs (Step 602); reconstructs the object from the applied high pass filtering using backprojection using GPU shader programs (Step 604); and removing ring and cupping artifacts from the reconstructed object using GPU shader programs (Step 606).

More particularly, Step 602 includes backprojecting the high-pass filtered image from projection coordinates into three dimensional (3D) voxel coordinates to produce a stack of image slices using a GPU shader program and Step 604 includes removing artifacts and cupping effects from the produced stack of images using GPU shader programs.

More particularly, the process uses the following GPU-accelerated pre- and post-filters in the pipeline:

1. Pre-Filtering (Step 600): Since raw data is usually noisy, a non-linear curvature-based filter is applied to all projection images. The filter smoothes the image in uniform regions but preserves the edges by taking the local curvature and gradient magnitude into account. The algorithm is based on work by Neskovic et al [P. Neskovic and B. B. Kimia, “Three-dimensional shape representation from curvature dependentsurface evolution”, IEEE International Conference on Image Processing, 1994. Proceedings. ICIP-94., Volume: 1, On page(s): 6-10 vol. 1, 13-16 November 1994]

2. Pre-Filtering (Step 602): The inverse Radon transform theory requires the images to be filtered with a high-pass ramp filter. The process uses the FFT to convolve the projection images with a high-pass filter. The GPU-accelerated FFT implementation is based on previous papers (see T. Schiwietz and R. Westermann, “GPU-PIV,” in VMV, pp. 151-158, 2004; and T. Schiwietz, T. Chang, P. Speier, and R. Westermann, “MR image reconstruction using the GPU,” in Medical Imaging 2006: Visualization, Image-Guided Procedures, and Display. Proceedings of the SPIE (2006)., pp. 646-655, April 2006, both incorporated herein by reference).

3. Backprojection (Step 604): The projection images are backprojected into the output volume. The process uses a voxel driven backprojection implementation. That is, for each voxel in the output volume the process asks for the corresponding pixel in the projection images. This is implemented using projective texture mapping described by Segal et al., (see M. Segal, C. Korobkin, R. van Widenfelt, J. Foran, and P. Haeberli, “Fast shadows and lighting effects using texture mapping,” SIGGRAPH Comput. Graph. 26 (2), pp. 249-252, 1992). Geometry-wise, a voxel is only considered as reconstructed correctly, if a certain percentage of all projection images have contributed to it. Therefore, the process counts the number of “valid” rays from source passing through each voxel, a ray being “valid” if it meets a “usable” pixel location on the projection image, and discard voxels below a user-defined minimum “valid” count limit. In contrast to publications by Mueller and Xu [see F. Xu and K. Mueller, “Accelerating popular tomographic reconstruction algorithms on commodity PC graphics hardware,” IEEE Transaction of Nuclear Science, 2005], the process implementation does not require two output volumes oriented along the axes perpendicular to the patient axis. This makes the combination pass obsolete and saves half of the memory.

4. Post-Processing (Step 606): Once a raw volume is reconstructed, reconstruction artifacts are removed by post-processing operations. First, the process removes ring artifacts. Typically, ring artifacts can be observed on the axial plane centered around the patient axis due to detector calibration errors. The ring artifacts are extracted using radial median filtering and circular smoothing. Finally, the isolated ring artifacts are removed from the original image. This filter is based on an algorithm by Zellerhoff et al. [see M. Zellerhoff, B. Scholz, E.-P. Ruehrnschopf, and T. Brunner, “Low contrast 3D reconstruction from C-arm data,” in Medical Imaging 2005: Visualization, Image-Guided Procedures, and Display. Edited by Galloway, Robert L., Jr.; Cleary, Kevin R. Proceedings of the SPIE, Volume 5745, pp. 646-655 (2005)., M. J. Flynn, ed., pp. 646-655, April 2005].

5. Post-Filtering (Step 606): The second post-processing filter is a cupping artifact removal. Low-frequency artifacts are removed from the output slices. In order to eliminate the artifacts, the process convolves every slice with a band-pass Butterworth kernel and adds the cupping signal, which is generated as the filter response, to the original slice, weighted by a scaling factor.

### System

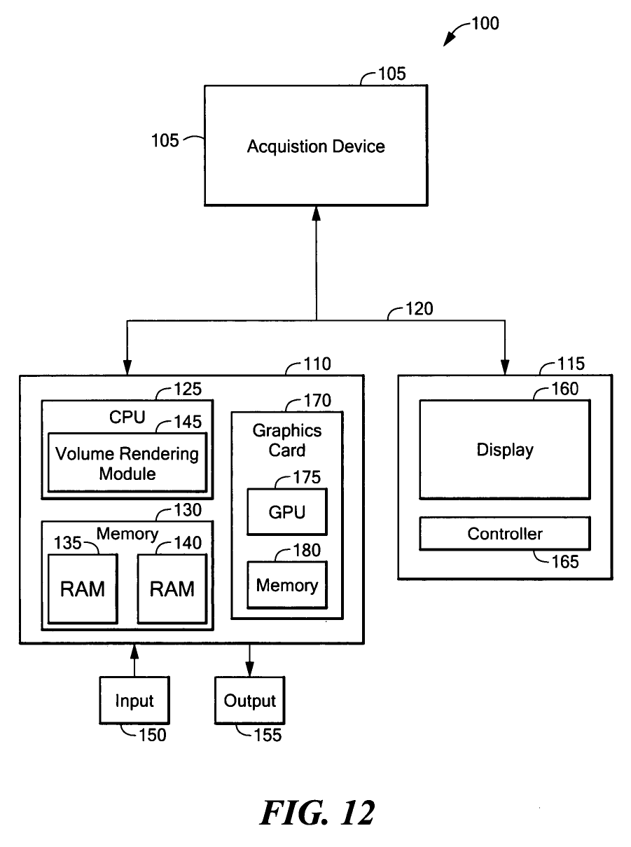

FIG. 12 is a block diagram of a system 100 for reconstructing an object subject to cone beam passing through the object and generating projection images of the object. As shown in FIG. 12, the system 100 includes, inter alia, an acquisition device 105, a personal computer (PC) 110 and an operator's console 115 connected over, for example, an Ethernet network 120. The acquisition device 105 is a X-ray source (MV or KV) and an amorphous silicon based flat panel mounted on opposite sides on the gantry of a Linear Accelerator or C-Arm or CT kind device, capable of making 360 degree rotation around the patient and acquire X-ray projection at regular angular interval.

The acquisition device 105 may further be a flatbed scanner that takes in an optical image and digitizes it into an electronic image represented as binary data to create a computerized version of a photo or illustration.

The PC 110, which may be a portable or laptop computer includes a CPU 125, a memory 130 and a graphics card 170, which are connected to an input device 150 and an output device 155. The CPU 125 includes a volume rendering module 145 that includes one or more methods for rendering a binary volume in a GPU. It is to be understood, however, that the volume rendering module 145 could be included in the graphics card 170.

The memory 130 includes a random access memory (RAM) 135 and a read only memory (ROM) 140. The memory 130 can also include a database, disk drive, tape drive or a combination thereof. The RAM 135 functions as a data memory that stores data used during execution of a program in the CPU 125 and is used as a work area. The ROM 140 functions as a program memory for storing a program executed in the CPU 125. The input device 150 is constituted by a keyboard or mouse and the output device 155 is constituted by a liquid crystal display (LCD), cathode ray tube (CRT) display or printer.

The graphics card 170, which is used to take binary data from the CPU 125 and turn it into an image, includes, inter alia, a GPU 175 and a memory 180. The GPU 175 determines what to do with each pixel to be displayed on, for example, the output device 155 or a display 160 of the operator's console 115. In operation, the GPU 175 makes a 3D image by first creating a wire frame out of straight lines, rasterizing the image and adding lighting, texture and color to the 3D image. The memory 180, which may be a RAM, holds information regarding each pixel and temporarily stores completed images. Although not shown, the graphics card 170 also includes a connection to a motherboard, which also holds the CPU 125, for receiving data and power and a connection to the output device 155 for outputting the picture.

It is to be understood that the memory 180 could be included in the GPU 175 or that the GPU 175 could include its own memory for performing certain storage tasks according to an exemplary embodiment of the present invention.

The operation of the system 100 is typically controlled from the operator's console 115, which includes a controller 165 such as a keyboard, and the display 160 such as a CRT display. The operator's console 115 communicates with the PC 110 and the acquisition device 105 so that 2D image data collected by the acquisition device 105 can be rendered into 3D data by the PC 110 and viewed on the display 160. It is to be understood that the PC 110 can operate and display information provided by the acquisition device 105 absent the operator's console 115, using, for example, the input device 150 and output device 155 to execute certain tasks performed by the controller 165 and display 160.

The operator's console 115 further includes any suitable image rendering system/tool/application that can process digital image data of an acquired image dataset (or portion thereof) to generate and display 2D and/or 3D images on the display 160. More specifically, the image rendering system may be an application that provides 2D/3D renderings and visualizations of medical image data, and which executes on a general purpose or specific computer workstation. Moreover, the image rendering system may enable a user to navigate through a 3D image or a plurality of 2D image slices. The PC 110 may also include an image rendering system/tool/application for processing digital image data of an acquired image dataset to generate and display 2D and/or 3D images.

The volume rendering module 145 may also be used by the PC 110 to receive and process digital medical image data, which as noted above, may be in the form of raw image data, 2D reconstructed data (e.g., axial slices), or 3D reconstructed data such as volumetric image data or multiplanar reformats, or any combination of such formats. The data processing results can be output from the PC 110 via the network 120 to an image rendering system in the operator's console 115 for generating 2D and/or 3D renderings of image data in accordance with the data processing results, such as segmentation of organs or anatomical structures, color or intensity variations, and so forth.

The remainder of the description is organized as follows. A general overview of GPU programming; a description of the stages of a GPU accelerated reconstruction pipeline; and a memory management algorithm and the corresponding pipeline algorithm.

### GPU Programming

Reference is made to T. Schiwietz, T. Chang, P. Speier, and R. Westermann, “MR image reconstruction using the GPU,” in Medical Imaging 2006: Visualization, Image-Guided Procedures, and Display. Proceedings of the SPIE (2006)., pp. 646-655, April 2006, and U.S. Patent Application Publication No. 2007/0014486 published Jan. 18, 2007, incorporated herein by reference. Reference is also made to the books J. D. Foley, A. van Dam, S. K. Feiner, and J. F. Hughes, Computer graphics (2nd ed. in C): principles and practice, Addison-Wesley Longman Publishing Co., Inc., Boston, Mass., USA, 1996. S. Thilaka and L. Donald, GPU Gems 2, ch. Medical Image Reconstruction with the FFT, pp. 765-784. Addison-Wesley, 2005. M. Woo, Davis, and M. B. Sheridan, OpenGL Programming Guide: The Official Guide to Learning OpenGL, Version 1.2, Addison-Wesley Longman Publishing Co., Inc., Boston, Mass., USA, 1999. K. Gray, Microsoft DirectX 9 Programmable Graphics Pipeline, Microsoft Press, Redmond, Wash., USA, 2003 and GPU Gems 2, Edited by Matt Pharr, Addison-Wesley, 2005.

Graphics cards provide readable and writable data structures in GPU memory. Basically, there are three types of data structures available: 1D, 2D, and 3D arrays, all referred to as textures. Among them, 2D textures provide the fastest update performance. The array elements of a texture are called texels. Each texel can have up to four float-typed components. The four components are often called the RGBA channels, as they are originally used to represent the red, green, blue, and alpha intensities of a color for rendering.

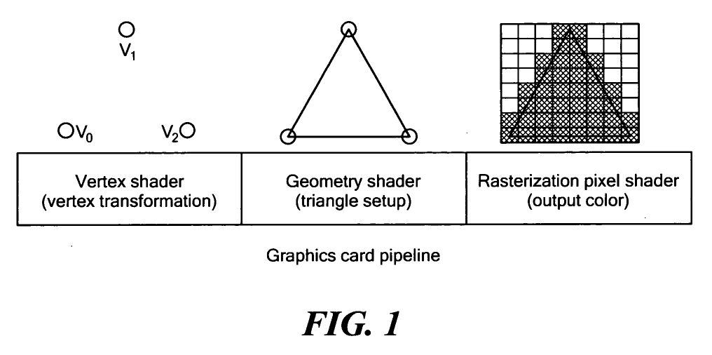

To set values in a texture, the GPU processing pipeline consisting of several stages is utilized. This procedure is also referred to as “rendering” which is carried over from the original convention when screen pixels are drawn by the pipeline. FIG. 1 illustrates three important stages in the graphics card pipeline. More particularly:

Vertex shader: A stream of vertices enters the vertex shader stage. A vertex is a data structure on the GPU with attributes such as position vectors for certain coordinate systems. In this stage, vertex attributes are manipulated according to the objectives of the applications. Traditionally, user-defined vertex shader programs are used to transform position vectors from one space to another.

Geometry shader (triangle setup): In this stage, sets of three vertices are selected to setup triangles according to a geometry shader program.

Rasterization/Pixel shader: Using the three vertices of each triangle as knot points, a scanline algorithm generates texels that are circumscribed by the triangle. All vertex attributes are interpolated bilinearly. User-defined pixel shaderprograms are executed for each rasterized texel, which can access and work with the interpolated vertex attributes. The following types of instructions are available in this stage.

Arithmetical instructions perform addition, multiplication, exponent, etc.

Data access instructions allow reading values from GPU memory.

Control flow instructions allow branching and loops.

A large number of temporary registers are available for intermediate results in the program. Each texel is rasterized and processed independently and potentially in parallel. However, no processing order can be assumed by the programmer. The return value of a pixel shader program is primarily a four-component vector, which is explained in detail next.

Particularly, the texture to be updated is set as the render target. This implies that the pixel shader now writes values to the texture instead of the screen. The area of the texture that the programmer wants to write to is covered by a quadrilateral defined by four vertices and two triangles. Using the graphics card pipeline, a pixel shader program is executed for each texel in the target texture. With this procedure, arbitrary calculations can be performed. In the context of the reconstruction pipeline, the projection images and the output volume are represented as textures and updated using pixel-shader programs.

Currently, the two major graphics programming APIs are DirectX and OpenGL. Both APIs provide similar functionality for graphics cards programming. Additionally, there are so called shading languages to program the vertex and pixel shader units on the graphics card. The DirectX shading language is called high-level shading language (HLSL); and the one for OpenGL is the OpenGL shading language (GLSL). Both languages provide similar functionality and their syntax is closely related to the C language. Here, implementations have been written in DirectX with HLSL.

### Pipeline Stages

The pipeline consists of the following five stages

Curvature Smoothing (projection image pre-processing) (Step 600, FIG. 6)

High-pass filter (projection image pre-processing) (Step 602, FIG. 6)

Backprojection (volume reconstruction) (Step 604, FIG. 6)

Ring artifact removal (volume post-processing) (Step 606, FIG. 6)

Cupping artifact removal (volume post-processing) (Step 606, FIG. 6)

### Curvature Smoothing

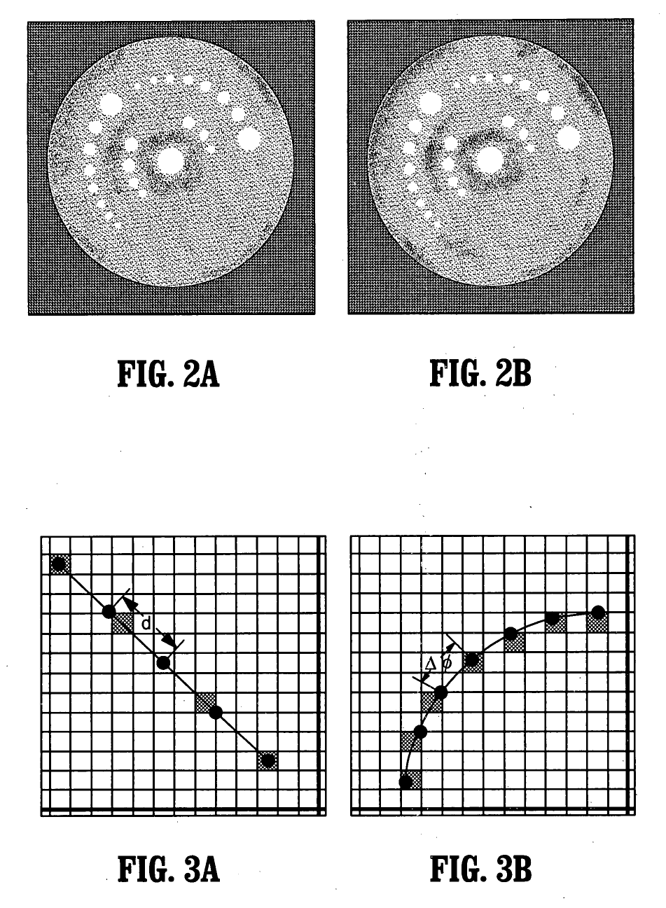

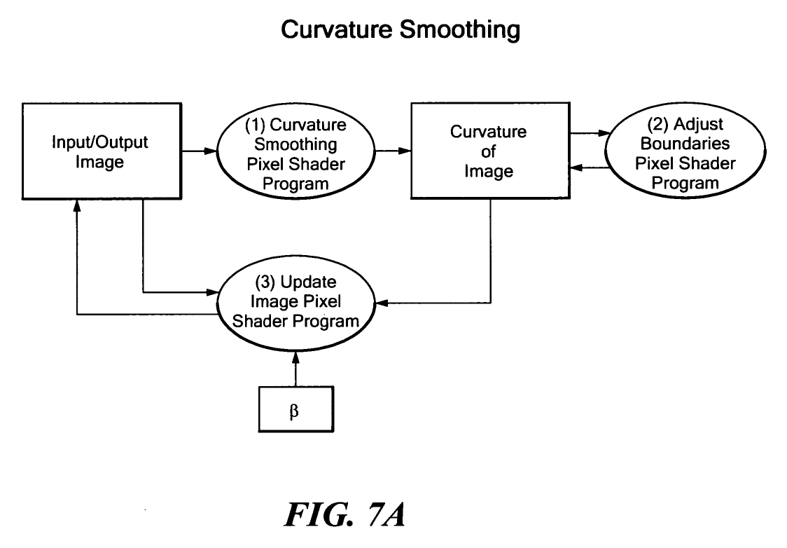

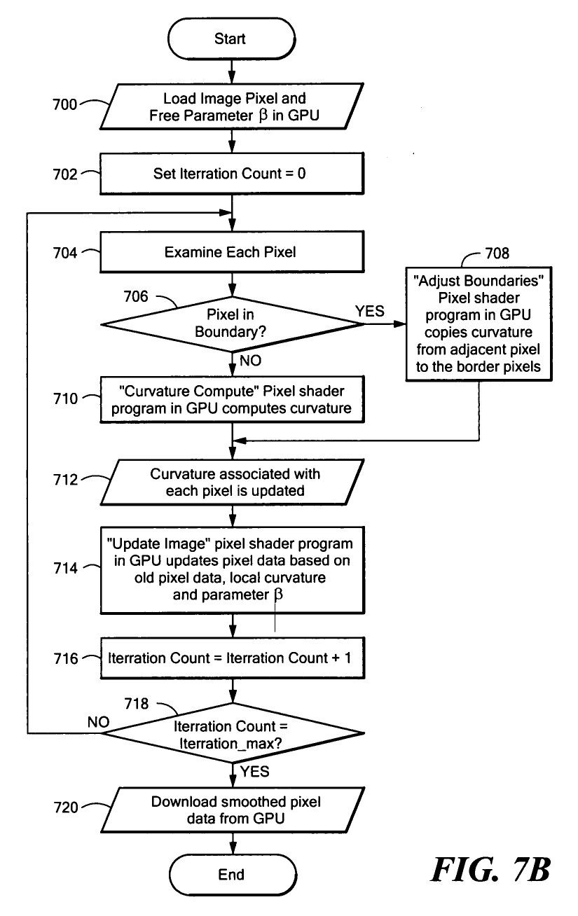

Usually, the projection image raw data is noisy, as shown in FIG. 2(A). The quality of the reconstructed output volume can be improved dramatically, if the noise in the projection images is reduced. An isotropic low-pass filter is not suitable because it not only reduces the noise but smoothes out the edges, too. Instead, the process uses a non-linear curvature based filter, shown in the flowcharts in FIGS. 7A and 7B. The algorithm smoothes the image iteratively according to the local curvature and gradient magnitude. It reduces noise while it preserves edges with larger gradient magnitude. The algorithm has been published by Neskovic et al. (see P. Neskovic and B. B. Kimia, “Geometric smoothing of 3d surfaces and non-linear diffusion of 3d images.”). In the following, the details of the algorithm are described:

A continuous scalar field φ is smoothed iteratively by the function φⁱ⁺¹=φⁱ+βC|∇φ| where C is the mean curvature

$$C = \frac{1}{2} ( {κ}_{1} + {κ}_{2} ) = \frac{{\vert ∇ ϕ \vert}^{2} trace ( H ( ϕ ) ) - ∇ {ϕ}^{T} H ( ϕ ) ∇ ϕ}{2 {\vert ∇ ϕ \vert}^{3}} , \qquad ( 1 )$$

H(φ) denotes the Hessian matrix of φ and β is a free parameter in range [0;1]. Equation 1 is derived from the fundamental forms as described by Farin [G. Farin, Curves and surfaces for CA GD: a practical guide, Morgan Kaufmann Publishers Inc., San Francisco, Calif., USA, 2002] and Eberly [D. H. Eberly, 3D Game Engine Design, Morgan Kaufmann Publishers Inc., San Francisco, Calif., USA, 2001. In two dimensions, Equation 1 evaluates to

$$C = \frac{\frac{{\partial }^{2} ϕ}{\partial {x}^{2}} {( \frac{\partial ϕ}{\partial y} )}^{2} + \frac{{\partial }^{2} ϕ}{\partial {y}^{2}} {( \frac{\partial ϕ}{\partial x} )}^{2} - 2 \frac{\partial ϕ}{\partial x} \frac{\partial ϕ}{\partial y} \frac{{\partial }^{2} ϕ}{\partial x \partial y}}{2 {\vert ∇ ϕ \vert}^{3}} \qquad ( 2 )$$

Equation 2 is discretized using central differences

$$\frac{\partial ϕ}{\partial x} = \frac{{p}_{i + 1 , j} - {p}_{i - 1 , j}}{2} , \\ \frac{\partial ϕ}{\partial y} = \frac{{p}_{i , j + 1} - {p}_{i , j - 1}}{2} , \\ \frac{{\partial }^{2} ϕ}{\partial {x}^{2}} = {p}_{i + 1 , j} - 2 {p}_{i , j} + {p}_{i - 1 , j} , \\ \frac{{\partial }^{2} ϕ}{\partial {y}^{2}} = {p}_{i , j + 1} - 2 {p}_{i , j} + {p}_{i , j - 1} , \\ \frac{{\partial }^{2} ϕ}{\partial x \partial y} = \frac{( {p}_{i - 1 , j - 1} + {p}_{i + 1 , j + 1} ) - ( {p}_{i - 1 , j + 1} + {p}_{i + 1 , j - 1} )}{4} \qquad ( 3 )$$

where p_{i,j} denotes the pixel intensity at the raster location (i, j). The curvature C is weighted by the gradient magnitude |∇φ| for normalization purposes. In order to prevent a division by zero in Equation 2, the algorithm returns 0 if the gradient magnitude |∇φ| gets small. Since no derivatives can be computed in the boundary region accurately, the process uses an out-flow boundary condition: the curvature of the direct neighbor perpendicular to the border tangent is replicated. After that, the image pixels p_{i,j} are updated by the weighted curvature βC|∇φ|. Usually, four to six iterations are sufficient for satisfying results.

The algorithm is implemented, as shown by the flowcharts in FIGS. 7A and 7B, using a GPU as follows: Two textures are allocated: one for the input image φ that is updated in each iteration, and the other one for the curvature C. A pixel shader program computes the curvature and writes the result to the curvature texture. With the discretization in Equation 3 only direct neighbors have to be accessed. The boundary condition is realized by rendering eight line primitives: four side borders and four corners. Texture coordinates are specified to address the source location where to copy the curvature from. Afterwards, another shader program updates the image texture φ with respect to β.

Thus, referring to FIGS. 7A and 7B, and more particularly to FIG. 7B, the process loads image pixel and free Parameter β into the GPU, Step 700. Next, the process sets an Iteration Count=0, Step 702. Next, the process examines each pixel, Step 704. Next, the process determines whether the pixel is in a boundary, Step 706. If it is, the process uses an “Adjust the Boundaries” pixel shader program in the GPU to copy curvature from adjacent pixels to boundary border pixels, Step 708; otherwise, the process uses a “Curvature Compute” Pixel shader program in GPU to compute object curvature, Step 710. Next, the process updates the curvature associated with each pixel, Step 712. Next, the process uses an “Update Image” pixel shader program in the GPU to update pixel data based on old pixel data, local curvature and parameter fÀ, Step 714. Next, the process makes Iteration Count=Iteration Count+1. Step 716. Next, the process determines whether Iteration Count=Iteration_max, Step 718. If not, the process returns to Step 702; otherwise, the process downloads smoothed pixel data from the GPU, Step 720.

FIGS. 2(A) and 2(A) show the effect of curvature smoothing used in the process according to the invention; FIG. 2(A) showing a noisy input image and FIG. 2 (B) showing the same image after eight iterations of curvature smoothing. Obviously, the noise is gone and the edges of the bright circles are still sharp.

### High-Pass Filtering

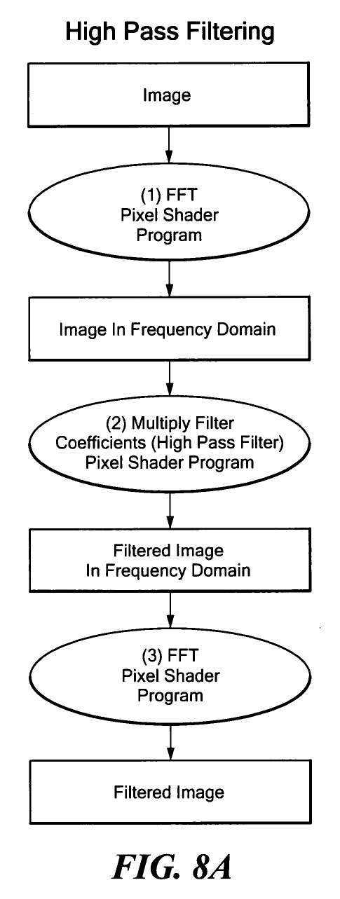

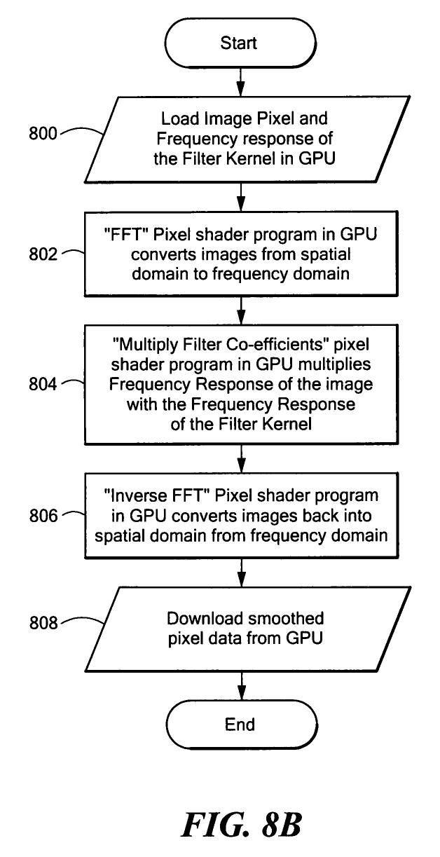

According to the inverse Radon transformation, a high-pass filter, for example, a ramp filter or a variation of that has to be applied to the projection images before the backprojection takes place. Commonly used filters are the Ram-Lak, Shepp-Logan, or the Hamming filter. Here, the process convolves the image with the Ram-Lak filter. The process uses GPU shader programs, as shown in the flowchart in FIGS. 8A and 8B, to transform the image to frequency domain, multiply the result pixel-wise by |f| where f is the frequency, and transform the result back to spatial domain. Implementation-wise the process uses an FFT implementation described in a paper by T. Schiwietz and R. Westermann, “GPU-PIV,” in VMV, pp. 151-158, 2004, and a paper by T. Schiwietz, T. Chang, P. Speier, and R. Westermann, “MR image reconstruction using the GPU,” in Medical Imaging 2006: Visualization, Image-Guided Procedures, and Display. Proceedings of the SPIE (2006)., pp. 646-655, April 2006, both incorporated herein by reference, on the GPU for the transformations.

More particularly, referring to FIGS. 8A and 8B, and more particularly to FIG. 8B, The process loads image pixel and frequency response of the filter kernel in the GPU, Step 800. Next, a “FFT” pixel shader program in the GPU converts images from the spatial domain to frequency domain, Step 802. Next, a “Multiply Filter Co-efficient” pixel shader program in the GPU to multiplies the Frequency Response of the image with the Frequency Response of the Filter Kernel, Step 804. Next, an “Inverse FFT” Pixel shader program in the GPU converts images back into spatial domain from frequency domain. Step 806. Then, the process downloads smoothed pixel data from the GPU, Step 808.

### Backprojection

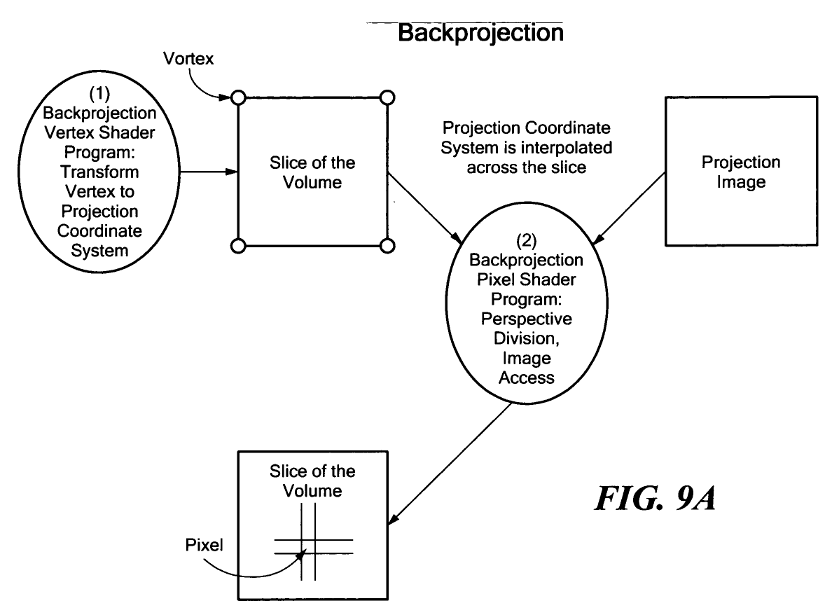

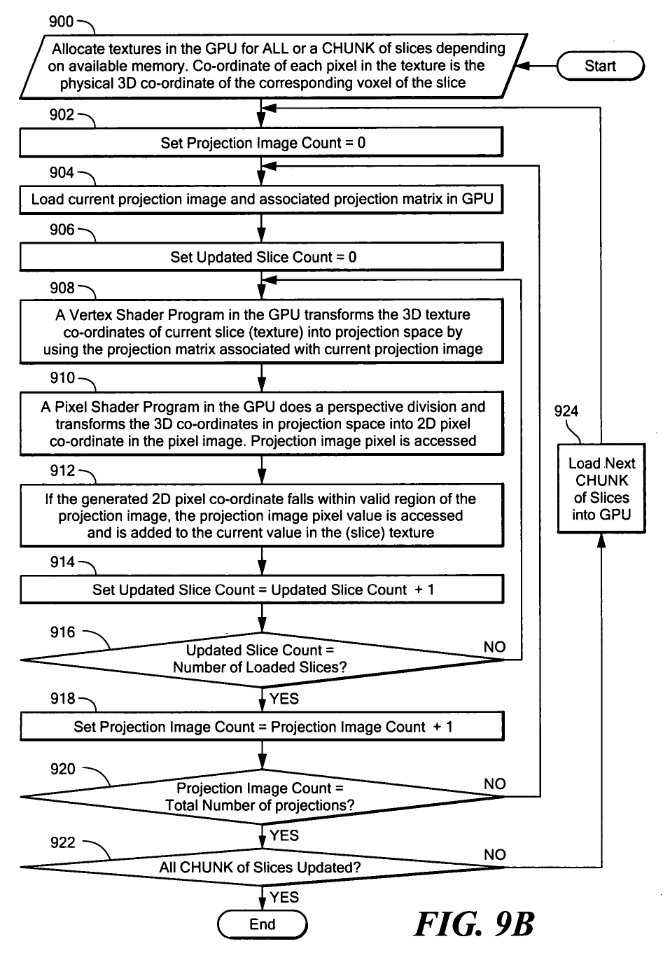

Principally, backprojection implementation works voxel-driven. That is, the process inquires for each voxel in the volume what the corresponding pixels in the projection image are. The process uses 2D textures to represent both the projection images and the slices of the output volume in GPU memory. The slices of the volume are updated using the techniques described above by rendering a quadrilateral covering the entire texture. 3D texture coordinates in projection space are specified at each vertex of the slices. Using the rasterization units the coordinates at the vertices are interpolated across the slice. The process uses GPU shader programs, shown in the flowchart in FIGS. 9A and 9B, fetches the interpolate coordinate inside the slice and performs the perspective division to project it to two dimensions. Next, the resulting 2D coordinate is checked against the margin of a valid area in the projection image. The valid area of projection image is user-defined. Only if the coordinate is inside the valid area the projection image is sampled and accumulated to the current slice of the volume weighted by the inverse squared depth. If the sample location is outside the valid area, the current voxel does not receive a contribution from the current projection image. The process counts the number of rays passing from the valid area of all projection images through all voxels. Only voxels with a user-defined percentage of valid rays hits are considered as reconstructed correctly. Invalid voxels are set to zero in post-processing.

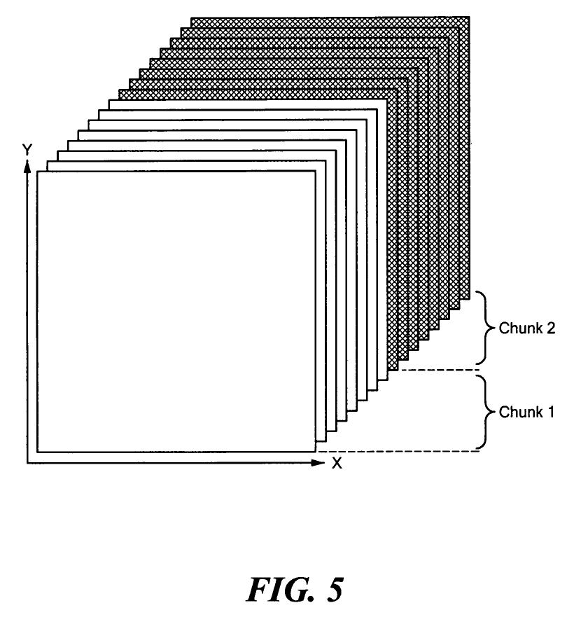

More particularly, referring to FIGS. 9A and 9B, and more particularly to FIG. 9B, The process allocates textures in the GPU for ALL or a CHUNK of slices (to be described in more detail in connection FIG. 5) depending on available memory Co-ordinates of each pixel in the texture is the physical 3D co-ordinate of the corresponding voxel of the slice, Step 900. Next, the process sets a Projection Image Count=0, Step 902. Next, the process loads current projection image and associated projection matrix into the GPU. Step 904. Next, the process sets Updated Slice Count=0, Step 906. Next, a Vertex Shader Program in the GPU transforms the 3D texture co-ordinates of current slice (texture) into projection space by using the projection matrix associated with current projection image, Step 908. Next, the process uses a Pixel Shader Program in the GPU performs a perspective division and transforms the 3D co-ordinates in projection space into 2D pixel co-ordinate in the pixel image and a projection image pixel is accessed, Step 910. If the generated 2D pixel co-ordinate falls within valid region of the projection image, the projection image pixel value is accessed and is added to the current value in the (slice) texture, Step 912; i.e., the generated 2D Pixel co-ordinate is not “valid” and makes no contribution to that voxel from that particular projection. Next, the process sets Updated Slice Count=Updated Slice Count+1, Step 912. The process then determines whether Updated Slice Count=Number of Loaded Slices, Step 916. If Updated Slice Count does not=Number of Loaded Slices, the process returns to Step 908; otherwise, the process sets Projection Image Count=Projection Slice Count+1, Step 918. Next, the process determines whether Projection Image Count=Total Number of projections, Step 920. If Image Count does not equal Total Number of projections, the process returns to Step 902; otherwise, the process determines whether All CHUNK of Slices have been Updated, Step 922. If All CHUNK of Slices have not been Updated, the process returns to loads the Next CHUNK of Slices into the GPU, Step 924 and then returns to Step 902; otherwise, the process ends.

### Ring Artifact Removal

Ring artifacts appear in the reconstructed volume because of detector calibration errors. Since the detector calibration can never be completely accurate, a post-processing filter helps to reduce the ring artifacts that arise typically. The algorithm is a 2D filter that is applied to all slices of the volume separately as the ring artifacts appear equally in each slice and not volumetrically. Basically, the algorithm extracts the ring artifacts and subtracts them from the original image. In detail, the algorithm works in four steps:

Dynamic range restriction: The dynamic range of the image is clamped to 11-bit [0; 2048] to avoid introducing artifacts from objects with high contrast.

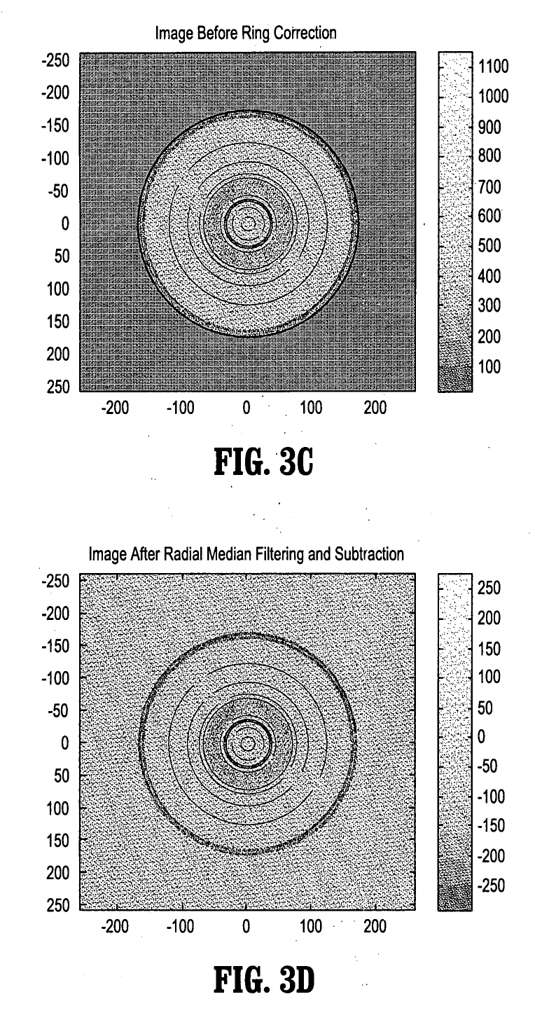

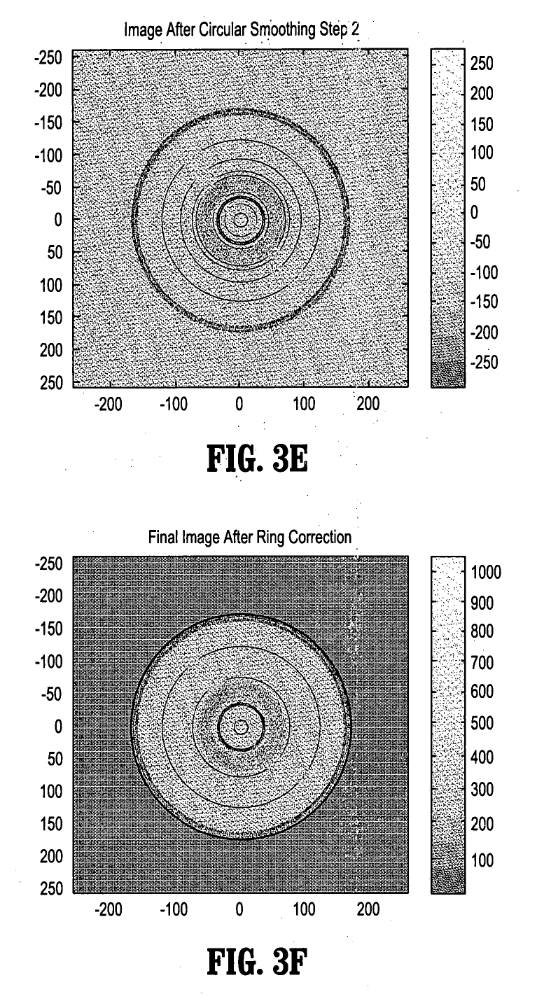

Median Filtering: Each pixel is filtered by the median of five samples along the radial line to the image center. FIG. 3 (A) depicts the radial line intersecting the image center at the lower right corner. The distance d between the sample points is the ring width depending on the gantry geometry. With a median of five samples the sample position are located at the distances [−2d;−d; 0; d; 2d] along the radial line. Finally, the median is subtracted from the original image in order to extract the ring artifacts.

Circular Smoothing: The extracted ring artifact image is refined by a circular smoothing filter in order to reduce the noise. The center of the circles is always located in the image center while the radius is the distance to the image center. The filter averages values along the circular neighborhood. The process uses a constant angular distance Δφ between the sample points. Here, the process uses six samples in both directions on the circle resulting in the average of 13 samples. FIG. 3(b) depicts the geometry of the circular sampling locations.

Correction: The extract ring artifacts are subtracted from the original image.

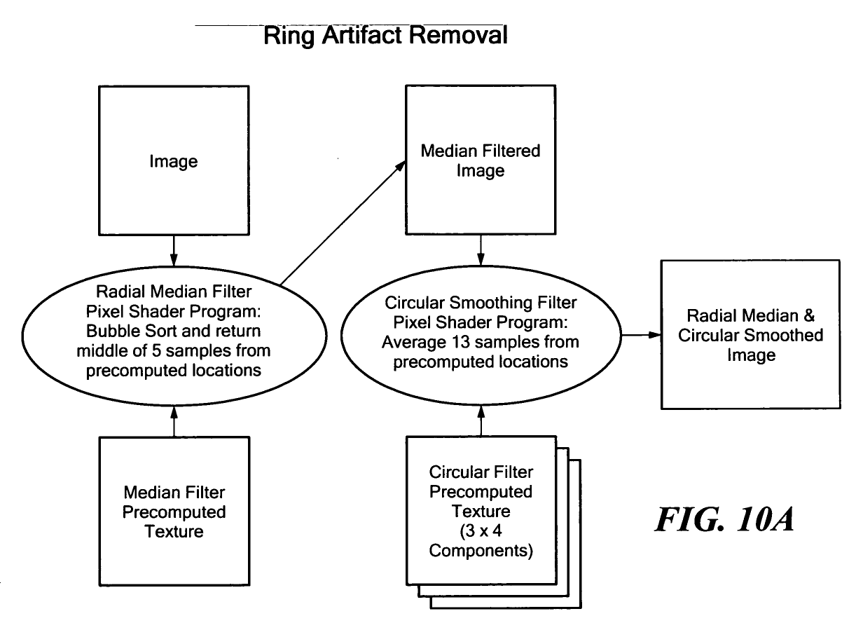

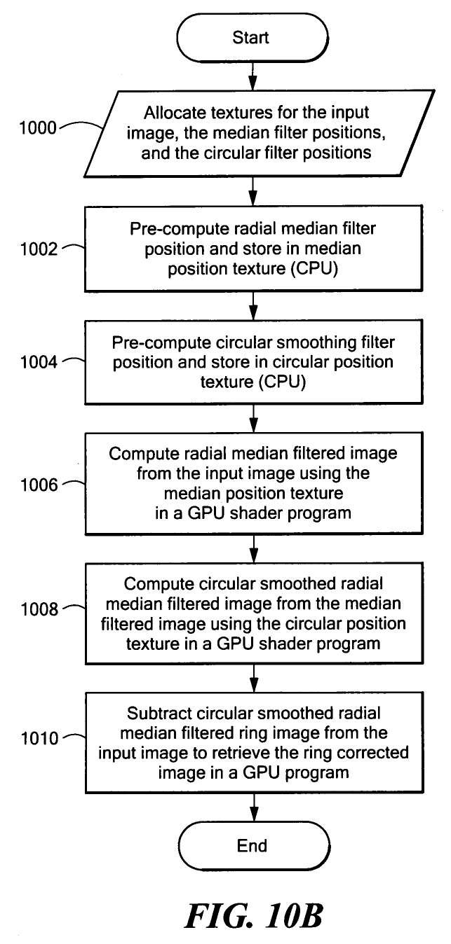

The process uses GPU shader programs shown in the flowchart in FIGS. 10A and 10B, pre-computes the sample locations for both the median and the circular filter pixel-wise. That is, the process uses Cartesian coordinates instead of polar coordinates in the precomputed tables. Furthermore, the process stores the linear addresses of the sample locations in the texture components to save memory. The linear address l at location (x, y) is computed with l(x, y)=(x·w)+y where w is the image width. The inverse functions l⁻¹(a) are defined as lₓ⁻¹(a)=(int)a%w and l_{y}⁻¹(a)=(int)a/w. The median filter requires four additional samples along the radial line for each pixel. A four component texture is sufficient to store the locations. A pixel shader program delinearizes the four positions, samples the values and computes the median by bubble sorting the values and returning the middle element subtracted from the pixel value in the original image. Similarly, the circular smoothing filter precomputes the sample locations in textures. Using the same addressing scheme, three textures with four components are allocated to store the 12 sample locations. A pixel shader program samples the 13 values and returns the average. In a final pass, the extracted ring artifacts are subtracted from the original image.

Thus, referring to FIGS. 3(A)-3(F), FIG. 3 (A) shows the sampling pattern for the radial median filter. The radial median filter samples four additional values in the distances [−2d; −d; d; 2d] along the radial line connecting the current pixel to the center of the image in the lower right corner. The image in FIG. 3(D) shows a radial median filtered image that was subtracted from the original input image. FIG. 3(B) shows the sampling pattern for the circular smoothing: it smoothes along the circular neighborhood. The circle mid-point is always located in the center of the image while the radius is the distance to the pixel to be smoothed. The samples are taken in equidistant angular steps Δφ. The image in FIG. 3(E) shows the effect of the filter applied on the image in FIG. 3(D). The image in FIG. 3(C) shows a slice with significant ring artifacts. After applying the ring artifact removal algorithm the image in FIG. 3(F) is free of artifacts.

The process is performed by GPU shader programs in accordance with the flowchart in FIGS. 10A and 10B. Thus, referring to FIG. 10B, the process allocates textures for the input image, the median filter positions, and the circular filter positions, Step 1000. Next, the process pre-computes median filter position and stores median position texture in the CPU, Step 1002. Next, the process pre-computes circular smoothing filter position and stores in circular smoothing position texture in the CPU, Step 1004. Next, the process computes median filtered image from the input image using the median position texture in a GPU shader program, Step 1006. Next, it computes circular-smoothing filtered image from the median filtered image using the circular smoothing position texture in a GPU shader program, Step 1008. Next, the process subtracts circular-smoothing filtered ring image from the input image to retrieve the ring corrected image in a GPU program, Step 1010.

### Cupping Artifact Removal

Cupping artifacts occur where a significant proportion of the lower energy photons in the beam spectrum have been scattered and absorbed. Typically, the artifacts are visible as low frequency error resulting in a non-uniform intensity distribution inside the image. In order to correct the cupping artifacts the low frequency errors must be identified and corrected. It can be observed that the cupping artifacts appear in range 0.4 to 4 cycles per image dimension. This filter band needs to be amplified and added to the original image. Formally, it can be expressed by the equation
f_{corr}(x,y)=F⁻¹[F[f(x,y)](1+kW(u,v))] (4)
where f(x, y) is the two dimensional input image, f_{corr}(x, y) is the corrected image, F(x, y) is the Fourier transform of the image f(x, y), W(u, v) is a low-pass filter to extract the cupping artifacts and k is a filter gain scalar. The process uses the Butterworth filter for W(u, v)

$${W}_{n} ( ω ) = \frac{1}{\sqrt{1 + {( \frac{ω}{{ω}_{h}} )}^{2 n}}} - \frac{1}{\sqrt{1 + {( \frac{ω}{{ω}_{l}} )}^{2 n}}} , \qquad ( 5 )$$

where ω=\sqrt{u²+v²} the angular frequency in radians per second, ωₗ the low cut off frequency, ωₕ the high cut off frequency, and n the order of the filter. In particular, the following parameter values are used:
Low cut off frequency ωₗ: 2 cycles per meter
High cut off frequency ωₕ: 3 cycles per meter
Filter order n: 2
Filter gain k: 2.25

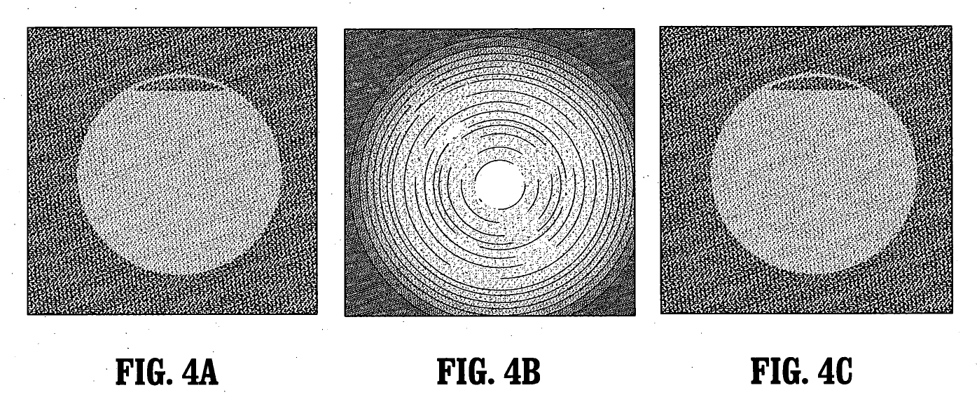

The filter response is the low frequency cupping artifacts residing in the image. It is added to the original image weighted by the filter gain k and shifted by (avg+max)/2 with the average and maximum value of the in the filter response. FIGS. 4A-4C show an input image (FIG. 4A) convolved with a Butterworth kernel (FIG. 4B). Image (FIG. 4C) is the (weighted) addition of image (FIG. 4A and FIG. 4B).

This algorithm has the following properties:
Translation invariant: low sensitivity to location of the object center
Low sensitivity to the object size
Little effect when cupping artifacts are not present
Very fast as only one forward/backward 2D FFT has to be computed

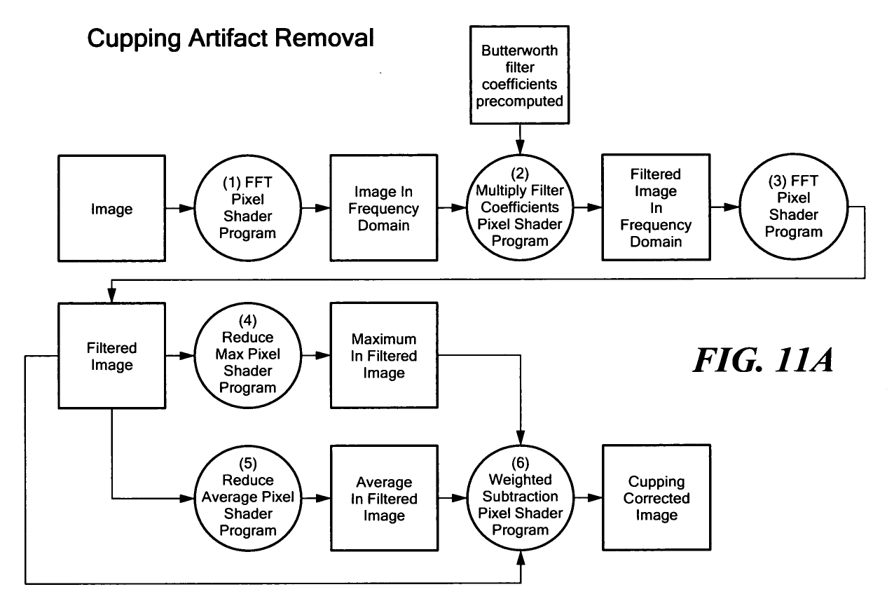

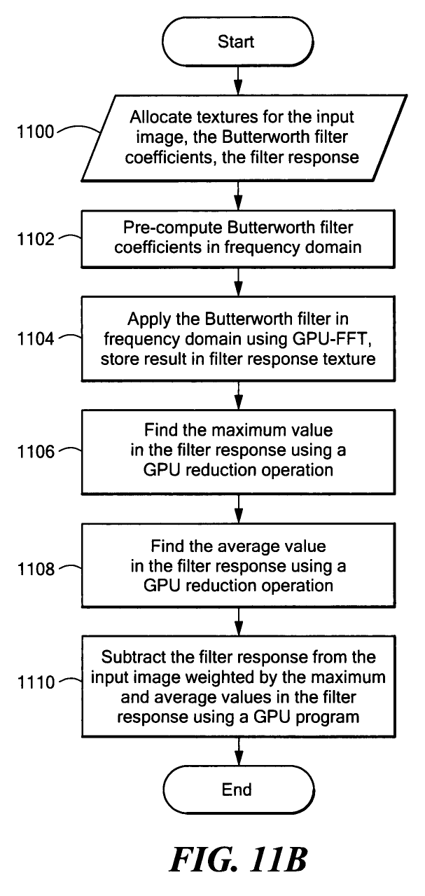

The process uses GPU shader programs, shown in the flowchart in FIGS. 11A and 11B, first calculates the Butterworth filter kernel and store the filter coefficients in a 2D texture. Then, the process convolves the filter kernel with the input image using GPU-based implementation of the FFT, see T. Schiwietz and R. Westermann, “GPU-PIV,” in VMV, pp. 151-158, 2004. T. Schiwietz, T. Chang, P. Speier, and R. Westermann, “MR image reconstruction using the GPU,” in Medical Imaging 2006: Visualization, Image-Guided Procedures, and Display. Proceedings of the SPIE (2006)., pp. 646-655, April 2006, both incorporated herein by reference. In order to compute the correct weight and shift for the correction, the maximum and average value in the filter response have to be determined. Therefore, the process uses two reduce operations on the filter response texture: a reduce maximum and a reduce average [J. Krüger and R. Westermann, “Linear algebra operators for GPU implementation of numerical algorithms,” ACM Transactions on Graphics (TOG) 22(3), pp. 908-916, 2003.]. Now, the DC of the filter response is corrected by subtracting (avg+max)/2 from each pixel weighted by the user-defined filter gain k. Finally, the original image is added resulting in an image without cupping artifacts.

More particularly, referring to the flowchart in FIG. 11B, the process allocates textures for the input image, the Butterworth filter coefficients, the filter response, Step 1100. Next, the process pre-computes the Butterworth filter coeffients in frequency domain, Step 1102. Next, the process applies the Butterworth filter in frequency domain using GPU-FFT, store result in filter response texture, Step 1104. Next, the process finds the maximum value in the filter response using a GPU reduction operation, Step 1106. Next, the process finds the average value in the filter response using a GPU reduction operation. Step 1108. Next, the process substracts the filter response from the input image weighted by the maximum and average values in the filter response using a GPU program. Step 1110.

Referring to FIGS. 4A-4C, FIG. 4A shows an input image; note typical cupping artifacts can be seen in the center of the image. The contrast falls off towards the center of the image. FIG. 4B shows the filter response after convolving the input image with the Butterworth filter; and FIG. 4C shows the image after cupping artifact correction. Note that now, the slice has a uniform intensity distribution.

With all pipeline stages described herein, reconstructed output volume is now of very high quality.

### Memory Management

Since GPU memory is limited and usually not big enough to store all projection images and the output volume, a memory management strategy is necessary. In this section, two memory management strategies are described and reconstruction pipeline algorithms are derived from them.

### Data Swapping

Nowadays, graphics cards have typically 512 MB of RAM. One can easily see that this is not enough memory to reconstruct a volume with 512×512×512 voxels in floating-point precision. A volume like this takes 512 MB. This does not fit into GPU memory since the graphics card driver uses some megabytes for internal buffers and, moreover, the projection images need to be stored in GPU memory as well. Therefore, a memory management strategy is required that swaps data between main memory and GPU memory. In general, both projection images and slices of the output volume can be swapped. Since the output volume does not fit into memory in one piece, the output volume is divided into chunks as depicted in FIG. 5. A chunk is a stack of slices representing a part of the entire volume. The slices of all chunks resemble the entire output volume. Two swapping strategies for projection images and chunks are described below, but hybrid forms are also possible. In particular, the amount of bus traffic between main memory and GPU memory is of interest. This is a bottleneck and must be minimized for optimal performance. To quantify the bus traffic the number of projection images are divided as pₙ and the size of one image in bytes as pₛ. Similarly, the number of chunks as cₙ are denoted and the size of one chunk in bytes are denoted as cₛ. In this context, copying data from main memory to GPU memory are called upload and vice versa called download.

Two Swapping Strategies

Swapping chunks: The projection image is the central pipeline element that stays in GPU memory until it is not needed anymore (pₙpₛ bytes upload, 0 bytes download). Each projection image is first pre-processed and then backprojected to the volume. Since the volume does not fit into GPU memory in one piece, all chunks have to be swapped in and out for each projection image (pₙ·cₙcₛ bytes upload and download).

Swapping projection images: First, all projection images are pre-processed (pₙpₛ bytes upload) and then stored in main memory (pₙpₛ bytes download). Next, the chunks are processed sequentially. For each chunk, all projection image are backprojected. That means that all projection images have to be uploaded for each chunk (cₙ·pₙpₛ bytes upload). Once a chunk is reconstructed completely, post-processing filters can be applied directly before it is downloaded (cₙcₛ downloads).

What strategy produces the smaller bus traffic depends on the size of a projection image and the size of the output volume. A typical scenario for us looks like this: In this example, there pₙ=360 projection images with 512×512 float-valued pixels pₛ=1 MB and the desired output volume with 512×512×512 floating-point voxels is divided into cₙ=3 chunks. Each chunk takes about cₛ=170 MB. Swapping chunks causes about 360 GB traffic, while swapping projection images causes only 2.25 GB of traffic. Therefore, here the implementation is based on the second approach.

| Swapping chunks | bytes upload | bytes download |
|---|---|---|
| Projection images | pₙ pₛ | 0 |
| Chunks | cₙcₛ · pₙ | cₙcₛ · pₙ |
| Projection images | pₙ pₛ + c · pₙpₛ | pₙ pₛ |
| Chunks | 0 | cₙcₛ |

### Swapping Projection Images Algorithm

Swapping projection images leads to the following reconstruction algorithm (in pseudo code):

for all projection Images
{

Upload projection image to GPU memory
Pre-Processing: Curvature Smoothing
Pre-Processing: High-pass Filtering
Download projection image to main memory

}
for all chunks
{

for all projection images
{

Upload projection image to GPU memory
Backproject image onto all slices of the chunk

}
Post-Processing: Ring Correction on all slices of the chunk
Post-Processing: Cupping Artifact Removal on all slices of the chunk
Download chunk to main memory

}

First, all projection images are preprocessed using the GPU. Therefore, the images are uploaded to GPU memory, the curvature smoothing filter and the high-pass are applied and the results are downloaded and saved in main memory. Then, the output volume is reconstructed chunk-by-chunk. All projection images are uploaded sequentially to GPU memory and backprojected to all slices of the chunk. Afterwards, the ring artifact removal and the cupping artifact removal are applied to the chunk in post-processing. Finally, the chunk is downloaded to main memory. This procedure is repeated for all chunks.

A number of embodiments of the invention have been described. Nevertheless, it will be understood that various modifications may be made without departing from the spirit and scope of the invention. Accordingly, other embodiments are within the scope of the following claims.

What is claimed is:

1. A method for reconstructing an object subject to cone beam passing through the object and generating projection images of the object, comprising:
applying curvature-based smoothing to the projection images using GPU shader programs;
applying a high-pass filter to the curvature-smoothed images using GPU shader programs;
reconstructing the object from the applied high pass filtering using backprojection using GPU shader programs; and
removing ring and cupping artifacts from the reconstructed object using GPU shader programs.

2. A graphic processing unit (GPU) having a program therein for upon execution of such program, reconstruct an object subject to cone beam passing through the object and generating projection images of the object, comprising: applying a high-pass filter to the curvature-smoothed images; reconstructing the object from the applied high pass filtering using backprojection; and removing ring and cupping artifacts from the reconstructed object.

3. A method for reconstructing an object subject to cone beam passing through the object and generating projection images of the object, comprising:
applying a non-linear curvature-based smoothing filter to the projection images;
applying a high-pass filter to the curvature-smoothed images;
backprojecting the projection images into an output volume using voxel driven backprojection; and
removing cupping artifacts from the output volume convolving every slice with a Butterworth kernel and adding the result to the slice weighted by a scaling factor.

4. A method for reconstructing an object subject to cone beam passing through the object and generating projection images of the object, comprising:
applying a non-linear curvature-based smoothing filter to the projection images, such filtering smoothing the projection images in uniform regions while preserves edges of the images by including local curvature and gradient magnitude effects;
applying a high-pass filter to the curvature smoothed images using a FFT to convolve the projection images with a high-pass filter;
backprojecting the projection images into an output volume using voxel driven backprojection, wherein for each voxel in the output volume the process request the corresponding pixel in the projection images, such backprojection comprising counting the number of rays passing through each voxel and discarding voxels below a user-defined minimum ray limit;
removing artifacts from the output volume comprising: removing ring artifacts from the output volume using radial median filtering and circular smoothing; and
removing cupping artifacts from the output volume comprising convolving every slice with a Butterworth kernel and adding the result to a weighted by a scaling factor.

5. A process comprising:
applying curvature-based smoothing and boundary adjustments to projection images using GPU shader programs;
applying high-pass filtering to the curvature-smoothed and boundary adjusted images using GPU shader programs;
reconstructing the object from the applied high pass filtering using backprojection using GPU shader programs; and
removing ring and cupping artifacts from the reconstructed object using GPU shader programs.

6. The method recited in claim 5 wherein reconstructing comprises backprojecting the high-pass filtered image from projection coordinates into three dimensional (3D) voxel coordinates to produce a stack of image slices using a GPU shader program.

7. The method recited in claim 3 wherein the output volume is divided into chunks, wherein a chunk is a stack of slices representing a part of the entire output volume.
